(19) United States
(12) Patent Application Publication
(10) Pub. No.: US 2006/0024502 A1
(43) Pub. Date: Feb. 2, 2006

(54) Electrodeposition of C60 thin films

(76) Inventors: Eric W. McFarland, Santa Barbara, CA (US); Alan Kleiman-Schwarsctein, Goleta, CA (US); Sung-Hyeon Baeck, Goleta, CA (US)

Correspondence Address: FULBRIGHT AND JAWORSKI LLP, 555 S. FLOWER STREET, 41ST FLOOR, LOS ANGELES, CA, 90071, US

(21) Appl. No.: 10/902,990

(22) Filed: Jul. 30, 2004

(51) Int. Cl. B32B 9/00; H01T 14/00

(52) U.S. Cl. 428/408; 427/580

(57) ABSTRACT

A method of preparing a fullerene-containing material by electrodepositing the material onto a substrate from a fullerene-derivative in solution or from a medium comprising water and a fullerene derivative. The substrate can be coated with a metal or metal compound to prepare a fullerene-doped metal thin film. In a further embodiment, a metal and fullerene-containing thin film is simultaneously electrodeposited onto a substrate from a medium comprising a fullerene derivative and an electrolyte composition suitable for electrodepositing a metal or metal compound.

### BACKGROUND

1. Field of Invention

This invention relates generally to fullerenes and in particular to the electrodeposition of fullerene-containing materials.

2. Related Art

Fullerenes are hollow carbon molecules based on hexagonal and pentagonal carbon rings. Carbon-60, the most symmetrical of the fullerenes, has 60 carbon atoms arranged in 12 pentagons and 20 hexagons. Other fullerenes having 36, 60, 70, 76, 78, 80, 82, 84, 86, 88, 90, 92, 94, 96, 98, 100, 102, 104, 106, 108, 110, 112, 114, 116, 118, and 120 carbon atoms, for example, have also been identified. Given their physical, chemical and optical properties, fullerenes are being developed for use in drug delivery, as superconductors, photoconductors, catalysts and catalyst supports, and for other applications.

The synthesis of uniform, electrically active thin films of fullerene-containing materials on electrodes and other surfaces has widespread application in the electronic, magnetic and optical devices fields as well as in the material systems field, which involves such technologies as fuel cell materials, chemical sensors, photovoltaic and photoelectrochemical cells. Fullerene-containing thin films have been prepared by thermal evaporation, electron beam evaporation, solvent evaporation, and electrodeposition.

Although electrodeposition can provide good control of film thickness, and can produce films with superior photoelectrochemical properties and potentially the most favorable electrical properties, the electrodeposition of fullerenes has been reported only in mixed solvents of toluene and acetonitrile (1, 2). The solubility of fullerenes in these solvents is limited, with the fullerenes forming suspensions of molecular clusters that require high voltages for deposition. Therefore, improved electrodeposition methods for preparing fullerene-containing materials, such as fullerene-containing thin films, are needed.

Titanium dioxide is a semiconductor that shows strong absorption in the UV range and that acts as a catalyst for the photodegradation of volatile organic compounds. Carbon doping provides a way to alter the electronic and catalytic properties of titanium dioxide, and to modify the characteristics of other metal and metal oxide catalysts of volatile organic compound degradation. The use of carbon doping in titanium dioxide has been studied with the aim of enhancing the photoelectronic and photocatalytic properties of titanium dioxide, and lowering bandgap position, to increase volatile organic compound oxidation (3-5). However, new methods of co-depositing carbon and metal or metal oxides are needed to take full advantage of carbon-doping technology.

### SUMMARY

In one aspect, the present invention is directed to a method of preparing a fullerene-containing material. The method involves depositing the material onto a substrate by electrodeposition from a fullerene derivative in solution. Electrodeposition in a medium containing a dissolved fullerene derivative provides a novel way to electrodeposit fullerene-containing materials. The deposition can occur at low voltages and at high fullerene concentrations, and can produce high quality, fullerene-containing thin films that are electrically conductive, optically active, and uniform in morphology and properties. Such films can be used in electronic, optical, electrochromic and electrode devices such as fuel cells, electrocatalysts, optical displays, smart windows, sensors, batteries, and coatings, and in devices for the oxidation of volatile organic compounds, including electrocatalytic and photocatalytic devices.

In another aspect, the present invention is directed to a method of preparing a fullerene-containing material which involves electrodepositing the material onto a substrate from a medium comprising water and a fullerene derivative. The fullerene derivative can be dissolved in the water-containing medium, or can form a suspension of fullerene aggregates or clusters.

The present invention also provides a method of preparing a material containing a fullerene and a metal or metal compound. The method involves electrodepositing the fullerene onto a substrate previously coated with the metal or metal compound. The coated substrate can be prepared by electrodeposition of the metal or metal compound, or by other means well known in the art such as thermal evaporation, electron beam evaporation, chemical vapor deposition, sputtering, spin coating, dip coating, and the like.

The present invention further provides a method of preparing a material containing a fullerene and a metal or metal compound by simultaneously electrodepositing the fullerene and the metal or metal compound onto a substrate from a medium comprising a fullerene derivative and an electrolyte composition suitable for electrodepositing the metal or metal compound. Although the fullerene derivative can form a suspension of fullerene aggregates or clusters, the fullerene derivative is preferably dissolved in the medium. The co-electrodeposition of a mixture of a fullerene and a metal or metal compound provides a new way of preparing carbon-doped semiconductor and catalytic materials.

Electrodeposited fullerene-containing materials can be unstable during the electrodeposition process. To minimize changes in film structure and morphology, a fullerene-coated substrate can be removed from a fullerene derivative in the electrodeposition medium prior to lowering or eliminating the electric field during electrodeposition. The pH, temperature and conductivity of the electrolyte can also influence film stability.

The novel features which are believed to be characteristic of the invention together with further features, aspects and advantages will be better understood from the following description and examples. It is to be expressly understood, however, that each example is provided for the purpose of illustration and description only and is not intended to define the limits of the present invention.

### BRIEF DESCRIPTION OF THE DRAWINGS

FIG. 1 is a graph showing cyclic voltammograms of a C60(OH)n solution as a function of pH;

FIG. 2 is a scanning electron micrograph of a thin film electrodeposited from a C60(OH)n solution;

FIG. 3(A) is a graph showing the X-ray photoelectron spectroscopy C 1s spectra for a thin film electrodeposited from a C60(OH)n solution;

FIG. 3(B) is a graph showing the X-ray photoelectron spectroscopy C 1s spectra for a thin film electrodeposited from a C60 PEG solution;

FIG. 4 is graph and an insert showing photocurrents for C60-doped titanium dioxide and pure titanium dioxide;

FIG. 5 is a graph of cyclic voltammograms showing Li+ ion intercalation, for comparing C60-doped tungsten oxide with pure tungsten oxide;

FIG. 6(A) is a graph of photocurrent as a function of calcination temperature under visible light illumination;

FIG. 6(B) is a graph of photocurrent as a function of calcination temperature under UV light illumination;

FIG. 7(A) is a scanning electron micrograph of electrodeposited ZnO;

FIG. 7(B) is a scanning electron micrograph of an electrodeposited C60-doped ZnO film; and

FIG. 7(C) is an energy dispersive x-spectroscopy spectra of an electrodeposited C60-doped ZnO film.

### DETAILED DESCRIPTION OF THE INVENTION

In accordance with the present invention, a fullerene-containing material is electrodeposited onto a substrate. Preferably, the material is in the form of a thin film or a nanostucture such as a nanowire. Electrodeposition from a fullerene derivative in solution can be carried out in any aqueous or non-aqueous medium suitable for electrodeposition in which the fullerene derivative is soluble. The non-aqueous medium can comprise any solvent suitable for dissolving a fullerene derivative, such as acetonitrile, dimethyl sulfoxide, tetrahydrofuran, acetone, an alcohol such as methanol, ethanol or propanol, or the like. Electrodeposition from a medium comprising water and a fullerene derivative can be carried out in any medium comprising water, such as an aqueous solution or a mixture of water and another solvent such as acetonitrile, so long as the water-containing medium provides a suitable environment for electrodeposition.

As used herein, the term “fullerene” means a hollow carbon molecule having hexagonal and pentagonal carbon rings. A fullerene derivative is any fullerene derived from a carbon-only fullerene such as C60 or C70, so long as the derivative can provide for electrodeposition from an appropriate medium. Preferably, the fullerene derivative is a nitrated, sulfated, carboxylated or hydroxylated fullerene derivative, or a fullerene derivative having one or more cyano groups, alkoxy groups, or polyethelene glycol (“PEG”) groups. More preferably, the derivative is a polyhydroxylated derivative in which the fullerene is Cm where m=36, 60, 70, 76, 78, 80, 82, 84, 86, 88, 90, 92, 94, 96, 98, 100, 102, 104, 106, 108, 110, 112, 114, 116, 118 or 120 carbons. More preferably still, the derivative is a polyhydroxylated C60 derivative such as C60(OH)n, where n can be an integer greater than one and less than or equal to 50, or a C60 PEG derivative such as C60-PEG-X where X refers to the molecular weight of a single PEG group, or two or more PEG groups. For example, a C60-PEG-X derivative can incorporate PEG of molecular weight Z and PEG of molecular weight Y, where Z+Y=X. Values for X can range from about 350-50,000. Preferably, X is 350, 550, 750, 1000, 2000, 5000 or 10,000.

The electrodeposition process can be performed under potentiostatic conditions, where the applied voltage remains constant, or under galvanostatic conditions, where the voltage can change while the current density remains constant. In a two electrode system having a working electrode and a counter electrode, applied voltage under potentiostatic conditions is measured between the two electrodes. In a three electrode system having a working electrode, counter electrode and reference electrode, applied voltage under potentiostatic conditions is measured between the working electrode and the reference electrode. Under galvanostatic conditions, the constant current is applied between the working and counter electrodes in a two or three electrode system.

The substrate for electrodeposition can be a material such as fluorine-doped tin oxide (“FTO”) coated glass, indium tin oxide (“ITO”) coated glass, graphite, stainless steel preferably at potentials of about −0.5 V<V vs Ag/AgCl<−4.0 V, or a conducting semiconductor. In addition, a substrate can comprise a narrow band gap semiconductor such as GaAs, GaN, GaInAS or GaP. Further, the substrate can comprise any Group III to Group XIV metal, metal oxide or metal hydroxide, or semiconductors thereof. Preferably, the substrate comprises Pt, Fe, Au, Ni, TiO2, WO3, ZnO, Cu2O, CuO, SiO2, stainless steel, Fe, Fe2O3, Fe3O4, Ni, NiO or ZrO. When electrodepositing a fullerene onto a substrate coated with a metal compound, the metal compound is preferably a metal oxide or metal hydroxide.

Electrodeposition can be carried out by electrodepositing a fullerene onto a substrate having multiple metal-containing layers with one or more fullerene-containing layers inserted between one or more of the metal-containing layers. Each metal-containing layer can comprise a metal or metal compound, which can be the same or a different metal or metal compound as in another metal-containing layer, and each fullerene-containing layer can comprise the same or different fullerene as another fullerene-containing layer. Preferably, the metal-containing layers alternate with the fullerene-containing layers in an M1-F1-M2-F2 . . . Mn-Fn arrangement, where M represents a metal-containing layer, F represents a fullerene-containing layer, and n can be a number greater than 1 and less than or equal to 1000. In preferred embodiments, the metal compound is a metal oxide or metal hydroxide. Each metal-containing layer and each fullerene-containing layer can be prepared by electrodeposition or by other means well known in the art. Preferably, each fullerene-containing layer is prepared by electrodeposition from a fullerene derivative in solution, or by electrodeposition from a medium comprising water and a fullerene derivative. An electrodeposited fullerene material can be secondarily processed chemically or by heating to convert the material to a chemically modified, fullerene-containing material. Similar to fullerene thin films, fullerene-containing materials having multiple layers can have utility in electronic, optical and electrode devices, as well as other applications.

The co-electrodeposition of a fullerene and a metal or metal compound entails electrodeposition from a medium comprising a fullerene derivative and an electrolyte composition for electrodepositing the metal or metal compound. The metal compound is preferably an oxide or hydroxide form of a metal, and the electrolyte composition preferably comprises a metal in salt form. Electrolyte compositions suitable for electrodepositing metal or metal compounds are well known in the art. In a preferred embodiment involving electrodeposition in an aqueous medium, the electrodeposition can be carried out at a deposition voltage in the range of about −0.1 to −2V vs Ag/AgCl, and at a temperature between 0° C. and 100° C. In general, electrodeposition can be carried out at a temperature between the boiling point and freezing point of the medium. Further processing of electrodeposited materials, such as by annealing at higher temperatures in air, oxygen or an inert atmosphere like N2 or Ar, can enhance the crystallinity of the materials and convert a metal or metal hydroxide to a metal oxide, and annealing in H2 can reduce a metal oxide or metal hydroxide to a metal. Preferred types of metals and metal compounds that can be incorporated into fullerene-containing thin films include metals such as Pt, Au and Zn, and metal compounds such as WO3, MoO3, WXMo1-XO3 (1>x>0), ZnO, Cu2O, CuO, and Fe2O3.

The electrodeposition medium can comprise a neutral chloride, nitrate, carbonate or sulfate salt of Li, Be, Na, Mg, K, Ca, Rb or Sr, for modifying the conductivity of the medium. Also, the medium can be purged (or saturated) with an inert gas before electrodeposition, during electrodeposition, or both before and during electrodeposition. Preferred inert gases include N2, He, and Ar. In addition, the medium can be purged with O2 or H2 gas before, during, or both before and during electrodeposition.

In a preferred embodiment, a fullerene-containing thin film is electrodeposited onto a conductive substrate from an aqueous solution comprising a fullerene derivative. The aqueous solution can be prepared by dissolving the desired fullerene derivative in water, preferably at a concentration of at least about 0.1 mg/ml of water, more preferably at a concentration of about 0.1 to 20 mg/ml of water. The pH of the solution can then be adjusted as necessary.

The quality of the electrodeposited thin films can be optimized by adjusting the fullerene-containing aqueous solution to a suitable pH. Preferably, the pH is in the range of about 0 to 10. More preferably, the pH is in the range of about 1 to 6. The pH is preferably adjusted by adding a strong acid such as sulfuric acid, nitric acid, and hydrochloric acid, or a strong base such as sodium hydroxide and ammonium hydroxide. Weak acids and bases can also be used as long as they provide a suitable solution pH. The pH can also be maintained with a buffer, but in general, it is preferable to limit the amount of additives to reduce the deposition of impurities and any redox chemistry resulting from the additives.

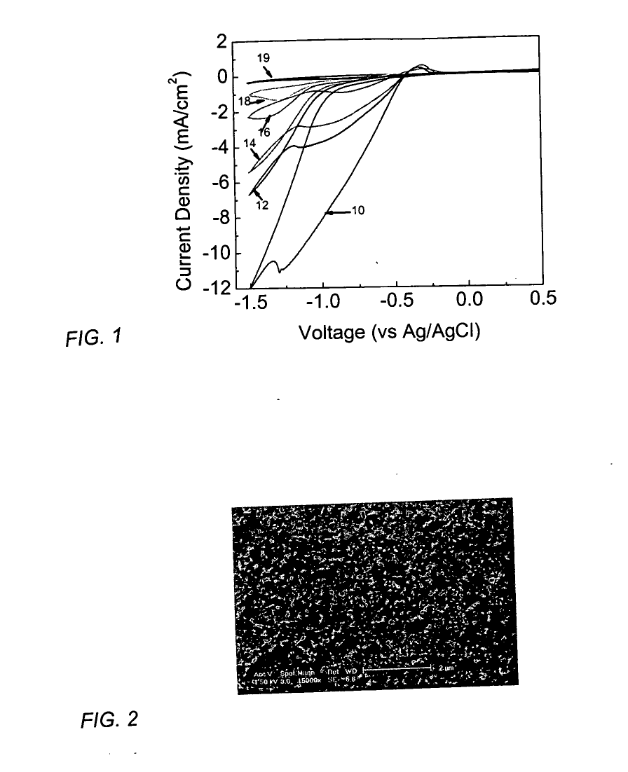

The current density of the deposition process can vary as a function of pH. This is shown in FIG. 1 by cyclic voltammograms of an aqueous solution containing C60(OH)n, n=2-50, a mixture of C60 molecules polyhydroxylated to various degrees, where the cyclic voltammograms are measured at pH 1 (curve 10), pH 2 (curve 12), pH 3 (curve 14), pH 4 (curve 16), pH 5 (curve 18) and pH 6 (curve 19). In this example, the current density increased with decreasing pH. Typically, higher current density results in thicker films. However, the electrodeposition process can be thought of as a balance between the rate of deposition of the fullerene-containing film on the substrate and the rate of dissolution of the deposited film from the substrate. Both rates can be strongly dependent on pH and deposition potential. Thus, at a suitable pH and deposition potential, deposition exceeds dissolution and a thin film can be electrodeposited.

Other conditions that can be important for electrodeposition include the conductivity of the solution and the temperature of the aqueous solution and electrodes. Preferably, the temperature of the aqueous solution and electrodes is in the range of about 0 to 100° C. The conductive substrate acts as a working electrode in the electrodeposition process.

The electrodeposition process can be carried out by immersing the conductive substrate (working electrode), a counter electrode and a reference electrode in the aqueous solution, then applying a potential between the reference electrode and the working electrode, or applying a current density between the working electrode and counter electrode. To maintain film integrity, the working electrode with its deposited thin film is preferably removed from the aqueous solution before reducing, increasing or removing the applied potential or current density. Reducing or eliminating the applied voltage before removing the thin film from the aqueous solution can destabilize the film and cause film etching and/or changes in film morphology. Also, as explained above, a suitably adjusted solution pH contributes to the stability and quality of the film. The combination of pH control and maintenance of applied potential can preserve the high quality of the film surface.

Although not preferred, the applied voltage can be changed before removing the electrodeposited thin film, especially in cases where the deposition rate is much greater than the dissolution rate, producing a relatively thick film.

The following examples illustrate the electrodeposition process.

### EXAMPLE 1

In this example, a fullerene-containing thin film is electrodeposited onto a conductive substrate from an aqueous solution containing a soluble C60 derivative.

To electrodeposit the thin film, C60(OH)n, n=2-50, a mixture of C60 molecules polyhydroxylated to various degrees, or a C60-PEG derivative was dissolved in water at a concentration of about 0.1 to 20 mg/ml of water. The pH of the solution was adjusted to obtain optimal film properties. The thin film was electrodeposited by immersing the conductive substrate (working electrode) in the fullerene-containing aqueous solution along with a platinum counter electrode and a Ag/AgCl reference electrode. Other counter electrodes such as graphite or the like are well known in the art and can be used. A potential between the reference electrode and the working electrode of between about −0.5 to −4 V was applied for a time, usually about 30 seconds to 10 hrs, depending on the desired thickness of the thin film. Preferably, the film is about 1-10 μm thick. To maintain film integrity, the working electrode with the thin film was removed from the aqueous solution before reducing or eliminating the applied potential.

A thin film prepared by electrodeposition from C60(OH)n, n=2-50, was characterized by scanning electron microscopy as shown in FIG. 2.

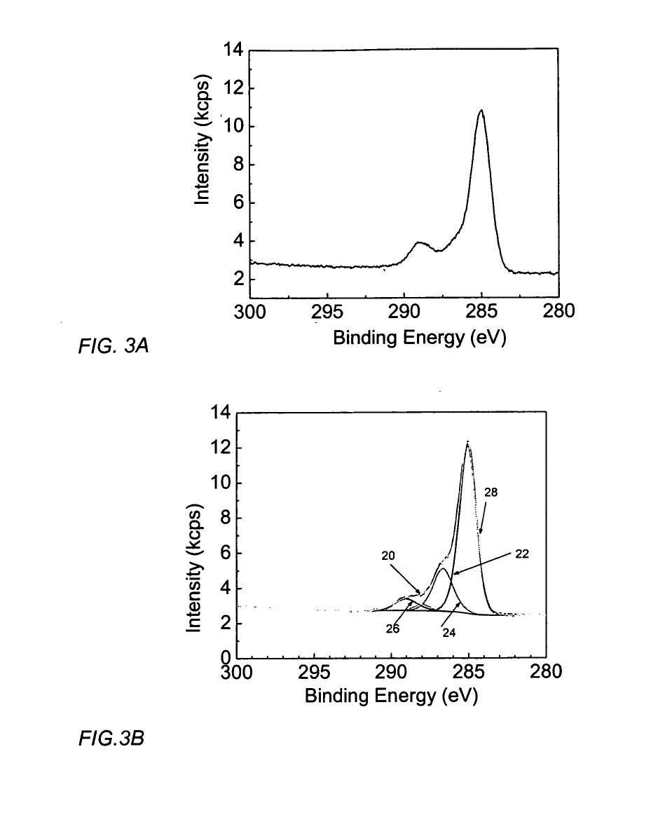

Thin films prepared by electrodeposition from C60(OH)n, n=2-50, or from C60-PEG-750 were characterized by X-ray photoelectron spectroscopy (“XPS”). FIG. 3(A) shows the XPS C 1s spectra obtained from a thin film prepared by electrodeposition from C60(OH)n, n=2-50. FIG. 3(B) shows the XPS C 1s spectra obtained from a thin film prepared by electrodeposition from C60-PEG 750. Shake-up satellites of carbon 1s photoelectrons are critical in distinguishing macromolecular carbon since the shake-up spectrum gives information on the excited states of the molecule under investigation, for example, pi→pi* transitions in a conjugated system like C-60. The shake-up satellites of both spectra in FIG. 3 are characteristic of C60-type structure. In FIG. 3(B), curve 20 is measured data; curve 22 is main C-1s, curve 24 is shake-up satellite at 1.7 eV; curve 26 is shake-up satellite at 3.8 eV; and curve 28 is curve-fitting envelope.

### EXAMPLE 2

In this example, a metal and fullerene-containing material is prepared by electrodepositing a fullerene onto a titanium oxide-containing substrate.

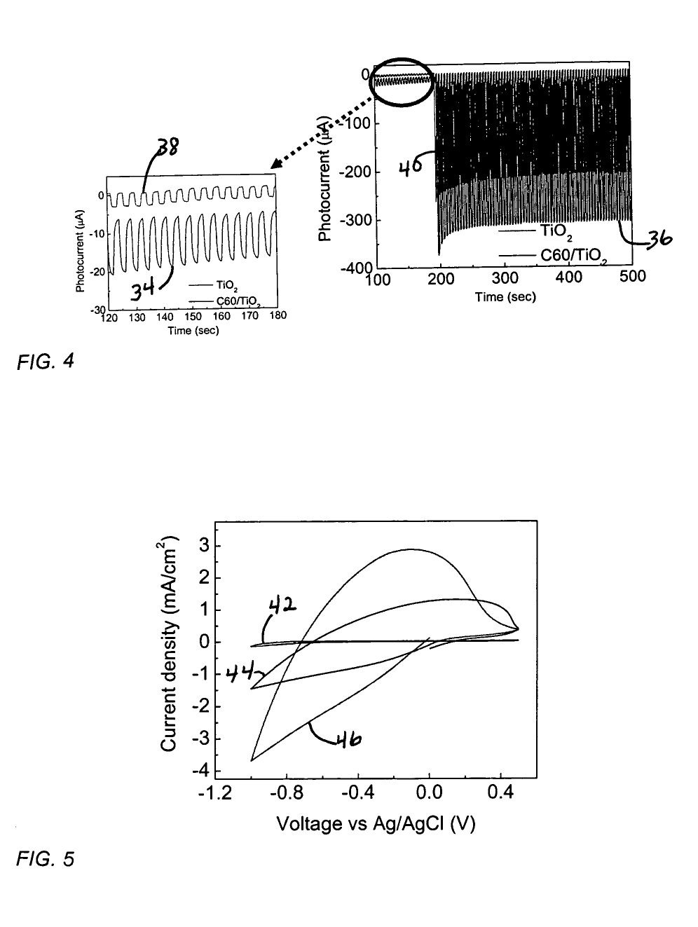

TiO2-coated substrates were prepared by electrodeposition of TiO2 onto a FTO substrate from a 10 mM-1M solution of Ti-ethoxide (pH 0-4), followed by calcination of the coated substrate at about 450° C. for about 4 hours. Alternatively, TiO2-coated substrates were prepared by thermal oxidation of Ti foil. A C60 fullerene-containing thin layer was electrodeposited onto a TiO2-coated substrate from an aqueous solution of C60(OH)n, n=2-50, at about −1 to −4 V vs Ag/AgCl reference electrode for about 5 minutes, as in Example 1. The C60(OH)n, n=2-50, was at a concentration of about 1 mg/ml in water, pH 2-4. FIG. 4 compares the photocurrent of a fullerene-doped titanium dioxide product with that of pure titanium dioxide. The photocurrent of fullerene-doped titanium dioxide 34 and 36 is higher in both the visible and UV region compared to the photocurrent of pure titanium dioxide 38 and 40.

In some cases, deposition of too thick a layer of C60 fullerene can result in a decrement of the photocurrent as compared to the TiO2 by itself. This effect can be related to the recombination rates or most probably to absorption and blocking of the light by the thick C-60 layer.

### EXAMPLE 3

In this example, a metal and fullerene-containing material is prepared by co-electrodeposition of tungsten oxide and a fullerene.

Thin films of C60 fullerene and WO3 were synthesized on a stainless steel substrate by co-electrodeposition. A 50 mM tungsten-peroxo complex, pH 2, was used as electrolyte and an aqueous solution of C60(OH)n, n=2-50, pH 2-4, was added to the electrolyte at a ratio of about 5-20% of carbon to tungsten. Electrodeposition was carried out at a deposition voltage of about −1.5 V vs Ag/AgCl reference electrode for about 15 minutes. Deposited films were investigated for electrochromic properties. Cation intercalations were carried out in a solution containing Li+. The electrochromic process of metal oxides has been explained by the double intercalation of a proton and an electron to form a colored metal bronze, and the integrated cathodic current density in cyclic voltammograms is a measure of the intercalation capacity.

FIG. 5 shows cyclic voltammograms for Li+ intercalation/deintercalation of an electrodeposited C60 fullerene film (curve 42), electrodeposited pure tungsten oxide (curve 44), and a C60 fullerene/WO3 film (curve 46). As expected, the C60 fullerene film did not show electrochromic properties. When compared with the cathodic current of pure tungsten oxide, C60-doped tungsten oxide film showed a higher current density. This indicates that to achieve a similar coloring current, a lower potential can be used for C60-doped tungsten oxide films, which can translate into greater efficiency.

### EXAMPLE 4

In this example, the photocatalytic activity of a C60-doped tungsten oxide film as a function of calcination temperature was investigated.

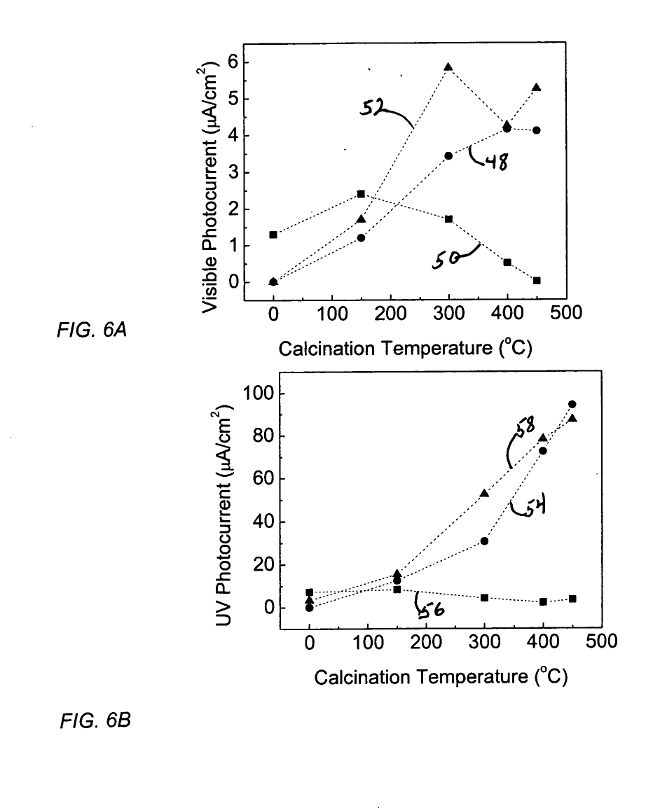

C60-doped tungsten oxide films were prepared as in Example 3. The deposited films were subjected to calcination by heating at various temperatures in air. Current measurements were obtained while samples were illuminated with visible light or UV light from a chopped Xe light source (Oriel, 1 kW). The electrolyte for the measurement of photocurrent contained a 0.1 M solution of sodium acetate, sodium hydroxide, potassium hydroxide or potassium nitrate. Photocurrents of electrodeposited films without bias are shown for visible light illumination in FIG. 6(A) and for UV light illumination in FIG. 6(B).

As shown in FIGS. 6(A) and 6(B), the photocurrent of tungsten oxide (curves 48 and 54) increased with increased calcination temperature due to increased crystallinity and decreased defect density. The photocurrent of C60 fullerene film (curves 50 and 56) was minimal under these conditions. As shown by the photocurrent of C60-doped tungsten oxide (curves 52 and 58), calcination can improve the photocatalytic properties under both visible and UV light illumination. In these studies, 300° C. calcination provided the most improvement.

### EXAMPLE 5

In this example, thin films of ZnO and C60 fullerene were prepared by co-electrodeposition.

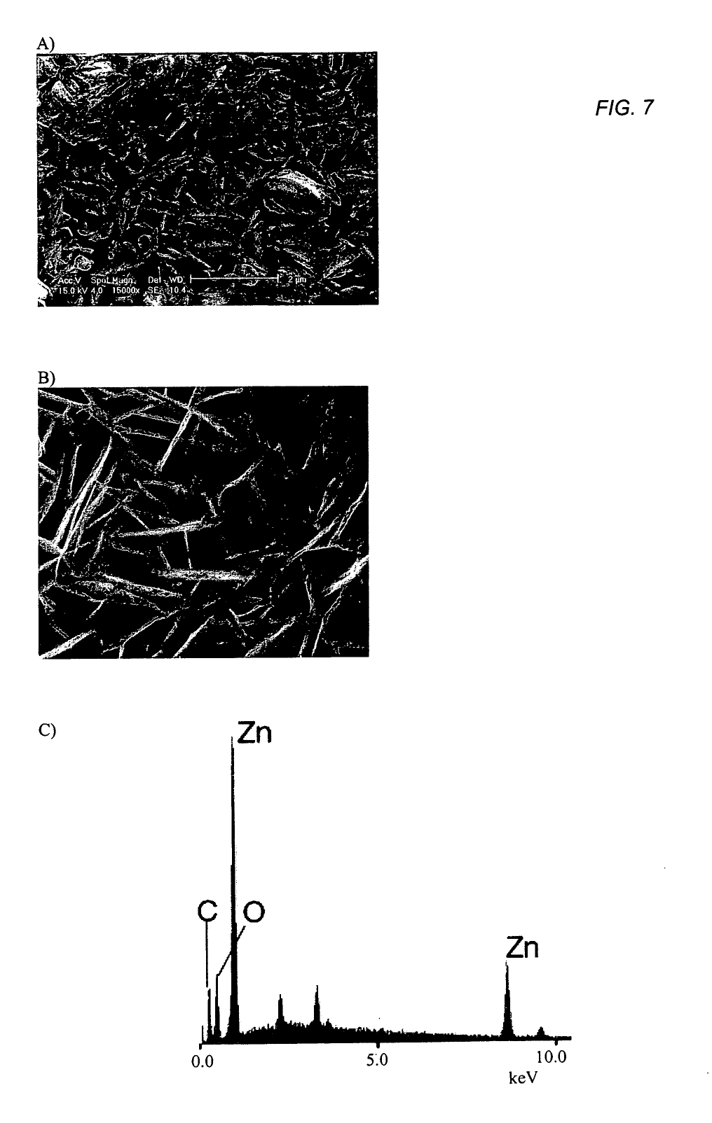

Thin films of ZnO and C60 fullerene were co-electrodeposited onto a FTO substrate from a mixture of 0.1M zinc nitrate (pH 6) and an aqueous solution (pH 2) of C60(OH)n, n=2-50, with a final C60(OH)n, n=2-50 concentration of about 1 mg/ml. Electrodeposition was carried out at 65° C. for about 1 to 30 minutes at a deposition voltage of about −0.3 to −3V vs Ag/AgCl reference electrode. The electrodeposition of zinc oxide alone from an aqueous solution of zinc nitrate at 60° C. provided a zinc oxide film with high crystallinity. FIG. 7(A) shows a scanning electron microscope image of pure zinc oxide. FIG. 7(B) shows a scanning electron microscope image of a C60-doped zinc oxide film electrodeposited from aqueous solution. Both images show needle like crystalline shapes. An energy dispersive x-spectroscopy spectra (EPS), shown in FIG. 7(C), confirmed that C60 fullerene was successfully co-deposited with zinc oxide.

### EXAMPLE 6

In this example, C60 fullerene-containing thin films were prepared by electrodeposition from a solution of a non-aqueous solvent, dimethylsulfoxide (“DMSO”).

To prepare fullerene-containing thin films, C60(OH)n, n=10-50, or a C60-PEG derivative were dissolved in DMSO at a concentration of about 0.1 to 2 mg/ml of DMSO. A thin film was electrodeposited by immersing a conductive substrate (working electrode) in the fullerene-containing DMSO solution along with a platinum counter electrode and a Ag reference electrode. Other counter electrodes such as graphite or the like are well known in the art and can be used. A potential between the reference electrode and the working electrode of between about −2 to −5 V was applied for a time, usually about 30 seconds to 10 hrs, depending on the desired thickness of the thin film. Preferably, the film is about 1-10 μm thick. To maintain film integrity, the working electrode with the thin film was removed from the aqueous solution before reducing or eliminating the applied potential.

The following references are incorporated herein by reference in their entirety.

### REFERENCES

1. P. V. Kamat, S. Barazzouk, K. George Thomas and S. Hotchandani, J. Phys. Chem. B 104, 4014 (2000).
2. Y.-G. Guo, C.-J. Li, L.-J. Wan, D.-M. Chen, C.-R. Wang, C.-L. Bai and Y. G. Wang, Adv. Func. Mater. 13(8), 62 (2003).
3. S. Sakthivel and H. Kisch, Angew. Chem. Int. Ed., 42, 4908 (2003).
4. A. Fujishima, K. Kohayakawa, and K. Honda, J. Electrochem. Soc., 122(11), 1487 (1975).
5. S. Khan, M. Al-Shahry, and W. B. Ingler, Science, 297(5590), 2243 (2002).

What is claimed is:

1. A method of preparing a fullerene-containing material, the method comprising:
a) dissolving a fullerene derivative in a medium; and
b) depositing the material onto a substrate by electrodeposition from the dissolved fullerene derivative.

2. The method of claim 1 wherein the medium is an aqueous or non-aqueous medium.

3. The method of claim 1 wherein the substrate comprises a coating of a metal or metal compound.

4. The method of claim 1 wherein the fullerene-containing medium is purged with an inert gas before electrodeposition, during electrodeposition, or both before and during electrodeposition.

5. The method of claim 1 wherein the fullerene-containing medium is purged with oxygen or hydrogen before electrodeposition, during electrodeposition, or both before and during electrodeposition.

6. The method of claim 1 wherein the medium comprises an electrolyte composition for simultaneously electrodepositing a metal or metal compound onto the substrate.

7. The method of claim 1 wherein the medium comprises a neutral chloride, nitrate, carbonate or sulfate salt of Li, Be, Na, Mg, K, Ca, Rb or Sr, for modifying the conductivity of the medium.

8. The method of claim 1 further comprising removing the substrate and electrodeposited material from the dissolved fullerene derivative before modifying electrodeposition potential.

9. The method of claim 1 wherein the substrate comprises multiple metal-containing layers with one or more fullerene-containing layers inserted between one or more of the metal-containing layers.

10. A method of preparing a fullerene-containing material, the method comprising:
a) dissolving a hydroxylated or polyethelene glycol-containing fullerene derivative in a non-aqueous medium; and
b) depositing the material onto a substrate by electrodeposition from the dissolved fullerene derivative.

11. A method of preparing a fullerene-containing material, the method comprising electrodepositing the material onto a substrate from a medium comprising water and a fullerene derivative.

12. The method of claim 11 wherein the medium is an aqueous solution of the fullerene derivative.

13. The method of claim 11 wherein the electrodeposition is conducted at a pH sufficient to stabilize the deposit.

14. The method of claim 11 wherein the substrate comprises a coating of a metal or metal compound.

15. The method of claim 11 wherein the medium is purged with an inert gas before electrodeposition, during electrodeposition, or both before and during electrodeposition.

16. The method of claim 11 wherein the medium is purged with oxygen or hydrogen before electrodeposition, during electrodeposition, or both before and during electrodeposition.

17. The method of claim 11 wherein the medium further comprises an electrolyte composition for simultaneously electrodepositing a metal or metal compound onto the substrate.

18. The method of claim 11 wherein the medium further comprises a neutral chloride, nitrate, carbonate or sulfate salt of Li, Be, Na, Mg, K, Ca, Rb or Sr, for modifying the conductivity of the medium.

19. The method of claim 11 further comprising removing the substrate with its electrodeposited material from the medium before modifying electrodeposition potential.

20. The method of claim 11 wherein the substrate comprises multiple metal-containing layers with one or more fullerene-containing layers inserted between one or more of the metal-containing layers.

21. A method of preparing a fullerene-containing material, the method comprising electrodepositing the material onto a substrate from an aqueous solution of a hydroxylated or polyethelene glycol-containing fullerene derivative.

22. A method of preparing a metal and fullerene containing material, the method comprising electrodepositing the material onto a substrate from a medium comprising a fullerene derivative and an electrolyte composition for electrodepositing a metal or metal compound.

23. A method of preparing a metal and fullerene containing material, the method comprising electrodepositing the material onto a substrate from an aqueous solution comprising a hydroxylated or polyethelene glycol-containing fullerene derivative and an electrolyte composition for electrodepositing a metal oxide.

24. A thin film prepared by the method of claims 1, 11, or 22.

25. A device comprising an electrode coated with a fullerene-containing thin film prepared by electrodepositing the thin film from a fullerene derivative in solution or by electrodepositing the thin film from a water and fullerene derivative containing medium.

26. An electrochromic device having the electrode of claim 25.

27. A device comprising a battery having the electrode of claim 25.

28. In a device comprising a sensor for detecting a chemical entity, having a surface sensitive to the chemical entity, the improvement wherein the surface is coated with a fullerene-containing thin film prepared by electrodepositing the thin film from a fullerene derivative in solution or by electrodepositing the thin film from a water and fullerene derivative containing medium.

29. In an oxidation device having a surface for oxidizing volatile organic compounds, the improvement wherein the surface is coated with a fullerene-containing thin film prepared by electrodepositing the thin film from a fullerene derivative in solution or by electrodepositing the thin film from a water and fullerene derivative containing medium.

30. In a catalytic device having a surface for catalyzing a reaction, the improvement wherein the surface is coated with a fullerene-containing thin film prepared by electrodepositing the thin film from a fullerene derivative in solution or by electrodepositing the thin film from a water and fullerene derivative containing medium.

31. The device of any of claims 25 to 30 wherein the thin film further comprises a metal or metal oxide.

32. In a coating for a substrate, the improvement wherein the coating comprises a fullerene-containing thin film prepared by electrodepositing the thin film from a fullerene derivative in solution, or by electrodepositing the thin film from a water and fullerene derivative containing medium.

33. The coating of claim 32 wherein the thin film further comprises a metal or metal oxide.

34. A method of preparing a fullerene-containing material, the method comprising electrodepositing the material onto a substrate that comprises multiple metal-containing layers with one or more fullerene-containing layers inserted between one or more of the metal-containing layers.

35. The method of claim 34 further comprising heating the electrodeposited fullerene-containing material to chemically modify the material.

36. The method of claim 34 further comprising chemically treating the electrodeposited fullerene-containing material to chemically modify the material.

37. A multilayered film prepared by the method of claim 34.

38. A device comprising the multilayered film of claim 37.
